(19) United States
(12) Patent Application Publication
(10) Pub. No.: US 2024/0212177 A1
(43) Pub. Date: Jun. 27, 2024

(54) INFORMATION PROCESSING DEVICE, INFORMATION PROCESSING METHOD, AND INFORMATION PROCESSING PROGRAM

(71) Applicant: SONY GROUP CORPORATION, TOKYO (JP)

(72) Inventors: AKIO HAYAKAWA, TOKYO (JP); NAOFUMI AKIMOTO, TOKYO (JP)

(21) Appl. No.: 18/557,305

(22) PCT Filed: Feb. 14, 2022
(86) PCT No.: PCT/JP2022/005656

§ 371 Date: Oct. 26, 2023

(30) Foreign Application Priority Data
May 17, 2021 (JP) 2021-083318

(51) Int. Cl. G06T 7/33; G06T 7/00; G06T 7/246; G06T 7/73

(52) U.S. Cl. CPC G06T 7/33; G06T 7/0002; G06T 7/246; G06T 7/73; G06T 2207/30196; G06T 2207/30232

(57) ABSTRACT

An information processing device (20) of an aspect according to the present disclosure includes a registration unit (231), an acquisition unit (232), and a generation unit (234). The registration unit (231) registers initial data indicating an initial state of a monitoring target. The acquisition unit (232) acquires feature point information indicating a feature point of the monitoring target detected on a time series basis. On the basis of the initial data and the feature point information, the generation unit (234) generates image information of the monitoring target that is in agreement with a predetermined condition.

### FIELD

The present disclosure relates to an information processing device, an information processing method, and an information processing program.

### BACKGROUND

Thus far, for example, there is known a report system whereby an abnormal situation occurring on an elderly person, a sick person, or the like who lives alone can be reported to a monitoring center without manual work for the purpose of saving labor of home care. Regarding such a system, for example, a care receiver watching system capable of reliably and quickly detecting an abnormality of a care receiver is proposed.

Further, these days, with the appearance of sensor devices capable of high-speed edge AI (artificial intelligence) processing, it is becoming possible to create applications corresponding to various solutions and construct an optimal system cooperating with a cloud system. By using such a sensor device, it is expected that a report system and a watching system like those described above will be further optimized.

### CITATION LIST

### Patent Literature

Patent Literature 1: JP 2020-91628 A

### SUMMARY

### Technical Problem

However, data of a monitoring target to be detected by the sensor device described above may not be configured in a state where the situation of the monitoring target can be easily recognized.

For example, the sensor device described above extracts, from sensing data, only data necessary for subsequent processing, and hence can achieve a reduction in data transfer delay time, consideration for privacy, reductions in power consumption and communication cost, etc. On the other hand, data itself extracted by the sensor device is not configured on the assumption that a person checks it, and hence may not be suitable for, for example, check work by visual observation.

Thus, the present disclosure proposes an information processing device, an information processing method, and an information processing program capable of providing data that allows easy recognition of a situation of a monitoring target by visual observation.

### Solution to Problem

To solve the above problem, an information processing device that provides a service that requires an identity verification process according to an embodiment of the present disclosure includes: a registration unit that registers initial data indicating an initial state of a monitoring target; an acquisition unit that acquires feature point information indicating a feature point of the monitoring target detected on a time series basis; and a generation unit that, on the basis of the initial data and the feature point information, generates image information of the monitoring target that is in agreement with a predetermined condition.

### BRIEF DESCRIPTION OF DRAWINGS

FIG. 1 is a diagram illustrating a configuration example of an information processing system according to an embodiment of the present disclosure.

FIG. 2 is a diagram illustrating an outline of information processing according to the embodiment of the present disclosure.

FIG. 3 is a block diagram illustrating a device configuration example of an information processing device according to the embodiment of the present disclosure.

FIG. 4 is a diagram illustrating an outline of monitoring target information according to the embodiment of the present disclosure.

FIG. 5 is a diagram illustrating an example of a flow of image information generation according to the embodiment of the present disclosure.

FIG. 6 is a flowchart illustrating an example of a processing procedure of the information processing device according to the embodiment of the present disclosure.

FIG. 7 is a diagram illustrating an example of key point data of a robot arm.

FIG. 8 is a diagram illustrating variations of key point data.

FIG. 9 is a block diagram illustrating a hardware configuration example of a computer corresponding to an information processing device according to the embodiment of the present disclosure.

### DESCRIPTION OF EMBODIMENTS

Hereinbelow, embodiments of the present disclosure are described in detail based on the drawings. In the following embodiments, components having substantially the same functional configuration may be denoted by the same numeral or reference sign, and a repeated description may be omitted. Further, in the present specification and the drawings, a plurality of components having substantially the same functional configuration may be described while being distinguished by attaching different numerals or reference signs after the same numeral or reference sign.

The description of the present disclosure is made according to the following item order.
1. Embodiments
1-1. System configuration example
1-2. Outline of information processing
1-3. Device configuration example
1-4. Processing procedure example
2. Supplementary items
2-1. With regard to processing of initial data
2-2. With regard to key point data
2-3. With regard to conditions for image information generation
3. Others
4. Hardware configuration example
5. Conclusions

### 1. EMBODIMENTS

### 1-1. System Configuration Example

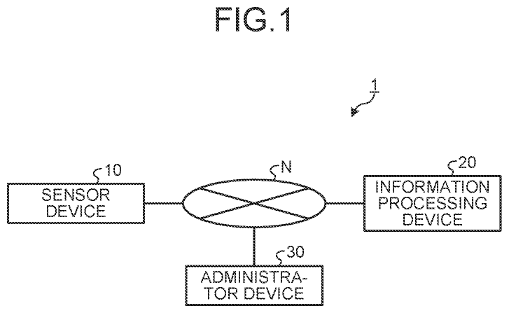

A configuration of an information processing system 1 according to an embodiment of the present disclosure will now be described using FIG. 1. FIG. 1 is a diagram illustrating a configuration example of an information processing system according to an embodiment of the present disclosure.

As illustrated in FIG. 1, the information processing system 1 according to the embodiment includes a sensor device 10, an information processing device 20, and an administrator device 30. FIG. 1 illustrates only an example of the information processing system 1 according to the embodiment, and the information processing system 1 may include larger numbers of sensor devices 10, information processing devices 20, and administrator devices 30 than in the example illustrated in FIG. 1.

The sensor device 10, the information processing device 20, and the administrator device 30 are connected by a network N in a wired or wireless manner. The sensor device 10, the information processing device 20, and the administrator device 30 can communicate with each other through the network N. The network N may include a public line network such as the Internet, a telephone line network, or a satellite communication network, various LANs (local area networks) including Ethernet (registered trademark), a WAN (wide area network), or the like. The network N may include a dedicated line network such as an IP-VPN (Internet protocol-virtual private network). Further, the network N may include a wireless communication network such as Wi-Fi (registered trademark) or Bluetooth (registered trademark).

The sensor device 10 acquires information regarding a person or an object to be a monitoring target. The sensor device 10 is obtained by using, for example, an intelligent vision sensor in which an image sensor portion (pixel chip) and a processing circuit portion (logic chip) are stacked by a stacking technology.

The sensor device 10 includes an arithmetic device and a memory. The arithmetic device included in the sensor device 10 is obtained by using, for example, a plurality of processors or a plurality of cache memories. The arithmetic device is a computer (information processing device) that executes arithmetic processing regarding machine learning. For example, the arithmetic device is used to calculate a function of artificial intelligence (AI). The function of artificial intelligence is, for example, learning based on learning data, inference based on input data, recognition, classification, data generation, etc., but is not limited thereto. The function of artificial intelligence can be achieved using, for example, a deep neural network. That is, the information processing system 1 illustrated in FIG. 1 can also be said to be an AI system that performs processing regarding artificial intelligence.

The sensor device 10 executes key point detection (also referred to as “attitude estimation”) of detecting, from image data acquired for a monitoring target, a key point (an example of a coordinate point or “feature point information”) that can be a feature point of the monitoring target. For example, when the information processing system 1 sets a certain person as a monitoring target, the sensor device 10 acquires skeleton information (coordinate information of joint points) of the person to be a monitoring target. The sensor device 10 can execute key point detection by using any technique such as a top-down approach such as Deep-Pose or a bottom-up approach such as Open-Pose.

Further, the sensor device 10 can transmit various pieces of data to the information processing device 20 via the network N by means of a communication processor. The various pieces of data transmitted by the sensor device 10 to the information processing device 20 include key point data detected by key point detection.

The sensor device 10 may include any sensor other than an image sensor. For example, the sensor device 10 may include a microphone, a human sensor, a position sensor, a temperature sensor, a humidity sensor, an illuminance sensor, a pressure sensor, a proximity sensor, a biological sensor that detects biological information such as odor, sweat, heartbeats, pulses, or brain waves, etc. The sensor device 10 may receive data from a plurality of sensors by wireless communication instead of including a plurality of sensors. The sensor device 10 can, for example, receive data from a plurality of sensors by a wireless communication function such as Wi-Fi (registered trademark) (Wireless Fidelity), Bluetooth (registered trademark), LTE (long-term evolution), 5G (a 5th generation mobile communication system), or LPWA (low power, wide area).

As described later, the information processing device 20 generates image information indicating a situation of a monitoring target on the basis of information acquired from the sensor device 10, and provides the image information to an administrator of the administrator device 30. The information processing device 20 is obtained by using a server device. Further, the information processing device 20 may be obtained by using a single server device, or may be obtained by using a cloud system in which a plurality of server devices and a plurality of storage devices connected to be able to communicate with each other through any network operate in cooperation.

The administrator device 30 is an information processing device used by an administrator of the information processing system 1. The administrator device 30 provides image information received from the information processing device 20 to the administrator by displaying and outputting the image information.

### 1-2. Outline of Information Processing

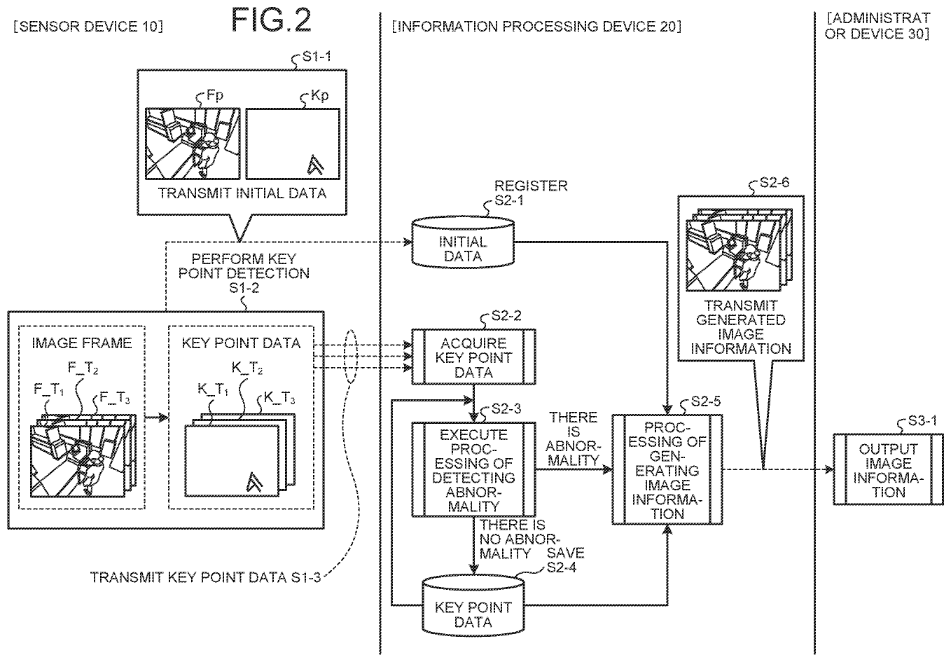

An outline of information processing according to the embodiment of the present disclosure will now be described using FIG. 2. FIG. 2 is a diagram illustrating an outline of information processing according to the embodiment of the present disclosure. FIG. 2 illustrates an example in which the information processing system 1 according to the embodiment of the present disclosure is used in the case where, for example, a supervisor monitors the state of an employee in a store. The information processing system 1 according to the embodiment of the present disclosure can be similarly used not only for a case where a supervisor monitors the state of a person who is a monitored person but also for a case where the state of a living space is monitored without ties of the supervisor or the monitored person or the state of an object other than a person, such as a manipulator or a working robot, is monitored.

The sensor device 10 transmits initial data to the information processing device 20 (step S1-1). The initial data includes one piece of initial image data Fp and corresponding initial key point data Kp. The photographing timing of the initial image data Fp included in the initial data varies depending on the type of the use scene or the abnormal situation to be detected. The sensor device 10 may acquire a plurality of pieces of initial image data Fp and corresponding initial key point data Kp while considering the influence on processing executed in the information processing device 20. Thereby, in the information processing device 20, the possibility that image information in which the situation of the monitoring target is accurately restored is generated can be increased.

The sensor device 10 continuously photographs the monitoring target from the start of monitoring, and executes key point detection for each image frame (step S1-2). Then, the sensor device 10 transmits, to the information processing device 20, key point data detected for each image frame by key point detection (step S1-3). The output of key point data may be in a form of directly outputting coordinates indicating feature points of the monitoring target or in a form of outputting with a heat map giving a score (probability) for each pixel included in image data; thus, any output form can be employed.

In the example illustrated in FIG. 2, image frame F_T₁ indicates an image frame of the monitoring target acquired by the sensor device 10 at time T₁. Image frame F_T₂ indicates an image frame of the monitoring target acquired by the sensor device 10 at time T₂ after time T₁. Image frame F_T₃ indicates an image frame of the monitoring target acquired by the sensor device 10 at time T₃ after time T₂.

In the example illustrated in FIG. 2, key point data K_T₁ indicates key point data detected by the sensor device 10 from image frame F_T₁. Key point data K_T₂ indicates key point data detected by the sensor device 10 from image frame F_T₂. Key point data K_T₃ indicates key point data detected by the sensor device 10 from image frame F_T₃. Key point data K_T₁ to key point data K_T₃ detected from the image frames are sequentially transmitted from the sensor device 10 to the information processing device 20.

On the other hand, upon receiving initial data from the sensor device 10, the information processing device 20 registers the received initial data (step S2-1). As initial image data Fp included in initial data, an image for which consent to photographing is gained or an image subjected to appropriate processing for protecting the privacy of the subject is used for each type of the use scene or the abnormal situation to be detected. For example, the information processing device 20 registers an image for which consent to photographing is gained as it is. Further, for an image for which consent to photographing is not gained, in order to protect the privacy of a person included in initial image data Fp, the information processing device 20 registers the image after performing processing such as blurring processing or scrambling processing with a predetermined encoder.

For example, a case where the state of interaction between a customer and an employee is assumed as a use scene will now be described. In this case, a time when the customer is detected in front of the employee is conceivable as the photographing timing of initial image data Fp. Consent can be gained in advance to photographing of the employee, whereas prior consent to photographing cannot be gained from the customer. Thus, the information processing device 20 registers initial data after performing blurring processing on the face of the customer included in the initial image data Fp. That is, in the registered initial image data Fp, a situation in the store including the employee and the customer subjected to blurring processing is shown.

For example, a case where monitoring of the state of an employee at a checkout counter is assumed as a use scene will now be described. In this case, a time before opening, a time when a customer is not detected in front of the employee, a timing when the employee starts to take charge of cashier work (a time when the employee is detected in front of the checkout counter), or any timing selected by the employee who is a cashier is conceivable as the photographing timing of initial image data Fp. Since the information processing device 20 gained prior consent to photographing of the employee, the information processing device 20 registers initial image data Fp included in initial data received from the sensor device 10 as it is. That is, in the registered initial image data Fp, a situation in the store including the employee located in front of the checkout counter is shown.

The processing of initial image data Fp included in initial data may be executed by the sensor device 10 instead of the information processing device 20 according to the arithmetic capacity of the sensor device 10.

Further, the information processing device 20 acquires key point data detected on a time series basis in the sensor device 10 (step S2-2). Then, on the basis of the acquired key point data, the information processing device 20 executes processing of detecting an abnormal state of the monitoring target (an example of a “predetermined condition”) (step S2-3). Any method can be employed as a method for detecting an abnormal state of the monitoring target. For example, the information processing device 20 may save reference key point data indicating a normal state for each monitoring target in advance, and may detect an abnormal state from a result of comparison between the reference key point data and key point data acquired from the sensor device 10. Alternatively, the information processing device 20 may detect an abnormal state of the monitoring target from key point data acquired from the sensor device 10 by using a learned model that is generated in advance by machine learning or the like in order to detect an abnormal state of the monitoring target on the basis of key point data.

In the case where an abnormal state is not detected (the case of “there is no abnormality”), the information processing device 20 saves key point data acquired from the sensor device 10 (step S2-4). Then, the information processing device 20 continues the processing of detecting an abnormal state.

On the other hand, in the case where an abnormal state is detected (the case of “there is an abnormality”), the information processing device 20 executes processing of, on the basis of initial data and key point data, generating image information of the monitoring target for which an abnormal state is detected (step S2-5). For example, the information processing device 20 can generate image information by using image data included in initial data and key point data by using known technology shown in the following reference literatures.
(Reference Literature 1) “First Order Motion Model for Image Animation” [Searched on May 10, 2021], Internet URL: https://arxiv.org/abs/2003.00196
(Reference Literature 2) “One-Shot Free-View Neural Talking-Head Synthesis for Video Conferencing” [Searched on May 10, 2021], Internet URL: https://arxiv.org/pdf/2011.15126.pdf

Specifically, the information processing device 20 estimates the amount of movement from the initial state to the time of abnormality detection of the monitoring target. That is, the information processing device 20 estimates the amount of movement of the monitoring target by taking, for each frame, differences of corresponding key points between those obtained from initial key point data and those obtained from key point data at the time of abnormality detection. Then, the information processing device 20 generates image information corresponding to the time of abnormality detection on the basis of the estimated amount of movement and one piece of initial image data Fp included in initial data initially registered for the monitoring target in question. The information processing device 20 may generate, as an image corresponding to the time of abnormality detection, a still image at the time point of abnormality detection or a moving image from the initial state to the time of abnormality detection.

The information processing device 20 transmits the generated image information to the administrator device 30 (step S2-6).

The administrator device 30 outputs image information received from the information processing device 20 (step S3-1), and provides the image information to an administrator.

As described above, in the information processing system 1 according to the embodiment of the present disclosure, the information processing device 20 generates image information of a monitoring target for which an abnormal state is detected on the basis of one piece of image data of the monitoring target registered in advance as initial data and key point data of the monitoring target detected on a time series basis, and provides the image information to an administrator. Thus, the information processing device 20 can provide the administrator with data that is easier for the administrator to recognize than key points themselves.

### 1-3. Device Configuration Example

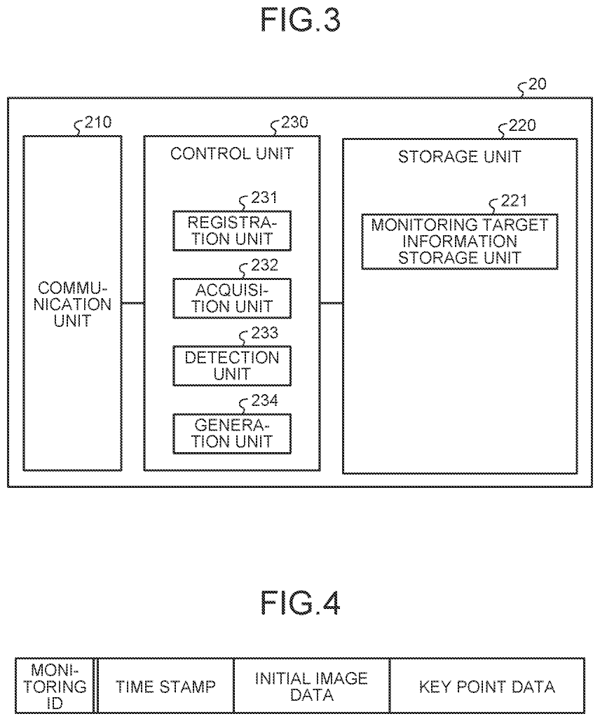

A device configuration of the information processing device 20 according to the embodiment of the present disclosure will now be described using FIG. 3. FIG. 3 is a block diagram illustrating a device configuration example of an information processing device according to the embodiment of the present disclosure.

As illustrated in FIG. 3, the information processing device 20 includes a communication unit 210, a storage unit 220, and a control unit 230. FIG. 3 illustrates only an example of the functional configuration of the information processing device 20 according to the embodiment, and the functional configuration is not limited to the example illustrated in FIG. 3 and may be other configurations.

The communication unit 210 transmits and receives various pieces of information. The communication unit 210 is obtained by using a communication module for performing data transmission/reception with other devices such as the sensor device 10 and the administrator device 30 in a wired or wireless manner. The communication unit 210 communicates with other devices by, for example, a system such as wired LAN (local area network), wireless LAN, Wi-Fi (registered trademark), infrared communication, Bluetooth (registered trademark), near field communication, or non-contact communication.

For example, the communication unit 210 receives initial data of a monitoring target from the sensor device 10. Further, the communication unit 210 transmits image information generated by the control unit 230 to the administrator device 30.

The storage unit 220 is obtained by using, for example, a semiconductor memory element such as a RAM (random access memory) or a flash memory, or a storage device such as a hard disk or an optical disk. The storage unit 220 can store, for example, programs, data, etc. for implementing various processing functions to be executed by the control unit 230. The programs stored in the storage unit 220 include an OS (operating system) and various application programs.

For example, as illustrated in FIG. 3, the storage unit 220 includes a monitoring target information storage unit 221. FIG. 4 is a diagram illustrating an outline of monitoring target information according to the embodiment of the present disclosure. As illustrated in FIG. 4, monitoring target information stored in the monitoring target information storage unit 221 is configured by associating a monitoring ID, a time stamp, initial image data, and key point data. FIG. 4 illustrates only an example of the monitoring target information, and the monitoring target information is not limited to the example illustrated in FIG. 4.

The monitoring ID is identification information individually allocated to an individual monitoring target in order to specify the monitoring target. The time stamp is information for specifying the date and time when initial image data is acquired by the sensor device 10 or the date and time when key point data is acquired. The initial image data is image information at the beginning of monitoring of the monitoring target acquired by the sensor device 10. The key point data is feature point information indicating feature points of the monitoring target acquired on a time series basis by the sensor device 10. The control unit 230 can, with a monitoring ID or the like as a key, acquire initial image data and key point data related to each other from the monitoring target information storage unit 221, and can use the data.

The control unit 230 is obtained by using a control circuit including a processor and a memory. The various pieces of processing to be executed by the control unit 230 are implemented by, for example, a process in which a command written in a program read from an internal memory by a processor is executed using the internal memory as a work area. The programs to be read from the internal memory by the processor include an OS (operating system) and an application program. The control unit 230 may be obtained also by using, for example, an integrated circuit such as an ASIC (application-specific integrated circuit), an FPGA (field-programmable gate array), or a SoC (system-on-a-chip).

A main storage device or an auxiliary storage device functioning as the internal memory described above is obtained by using, for example, a semiconductor memory element such as a RAM (random access memory) or a flash memory, or a storage device such as a hard disk or an optical disk.

As illustrated in FIG. 3, the control unit 230 includes a registration unit 231, an acquisition unit 232, a detection unit 233, and a generation unit 234.

The registration unit 231 stores initial data of a monitoring target in the monitoring target information storage unit 221. The registration unit 231 acquires initial data from the sensor device 10 via the communication unit 210. The initial data includes one piece of initial image data obtained by photographing the monitoring target (for example, the initial image data Fp illustrated in FIG. 2) and initial key point data detected from the initial image data (for example, the initial key point data Kp illustrated in FIG. 2). The registration unit 231 stores initial data in the monitoring target information storage unit 221 while associating the initial data with a monitoring ID issued in response to reception of the initial data. When storing initial data, the registration unit 231 records a time stamp together. The registration unit 231 may record the date and time of reception of initial data as a time stamp, or may extract date-and-time information from metadata attached to initial data and record the date-and-time information as a time stamp.

The acquisition unit 232 acquires key point data of a monitoring target detected on a time series basis. The acquisition unit 232 acquires key point data from the sensor device 10 via the communication unit 210. The acquisition unit 232 sends the acquired key point data to the detection unit 233.

The detection unit 233 detects an abnormal state of a monitoring target on the basis of key point data acquired by the acquisition unit 232. In the case where an abnormal state of the monitoring target is not detected, the detection unit 233 stores key point data in the monitoring target information storage unit 221 while associating the key point data with a monitoring ID issued by the registration unit 231. When storing key point data, the detection unit 233 records a time stamp together. The detection unit 233 may record the date and time of reception of key point data as a time stamp, or may extract date-and-time information from metadata attached to key point data and record the date-and-time information as a time stamp.

In the case where an abnormal state of the monitoring target is detected, the detection unit 233 sends key point data to the generation unit 234.

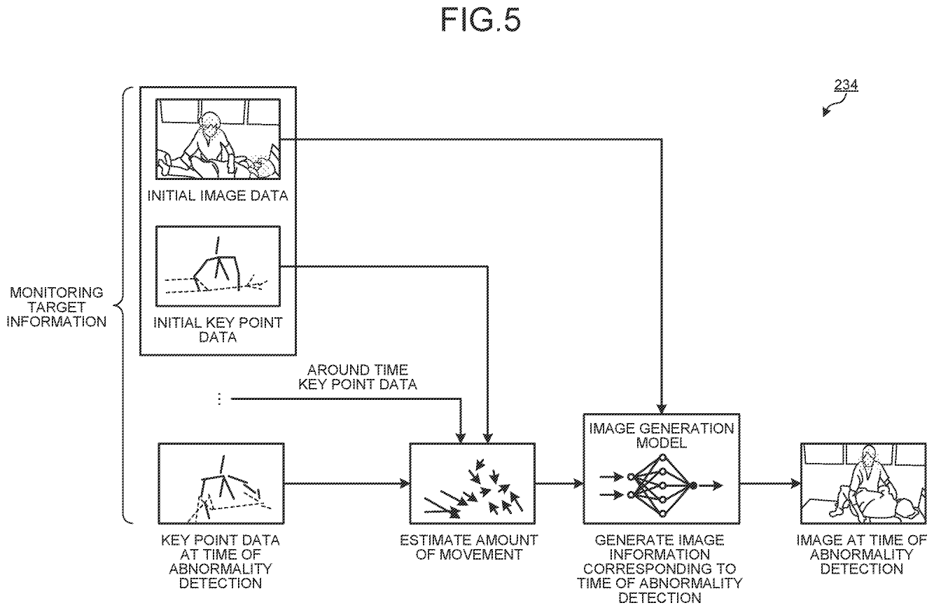

The generation unit 234 to generates, for example, image information of a monitoring target for which an abnormal state is detected on the basis of initial data and key point data. FIG. 5 is a diagram illustrating an example of a flow of image information generation according to the embodiment of the present disclosure.

For example, as illustrated in FIG. 5, when the generation unit 234 acquires, from the detection unit 233, key point data in which an abnormal state is detected, the generation unit 234 acquires initial key point data initially registered for the monitoring target and key point data associated with the time of detection of the abnormal state. The generation unit 234 may further acquire key point data associated with a time around the time of detection of the abnormal state. Subsequently, as illustrated in FIG. 5, the generation unit 234 uses the acquired key point data to estimate the amounts of movement of key points from the initial state to the time of detection of the abnormal state of the monitoring target. Then, as illustrated in FIG. 5, the generation unit 234 inputs, to an image generation model, the estimated amounts of movement and one piece of initial image data initially registered for the monitoring target in question, and generates image information corresponding to the time of abnormality detection. In the case where the image generation model can execute image generation from key point data, the generation unit 234 may input the acquired key point data and the initial image data to the image generation model. The generation unit 234 may generate, as an image corresponding to the time of abnormality detection, a still image of the monitoring target at the time point of abnormality detection, or a moving image of the monitoring target from the initial state to the time of abnormality detection.

The generation unit 234 transmits the generated image information to the administrator device 30 via the communication unit 210.

### 1-4. Processing Procedure Example

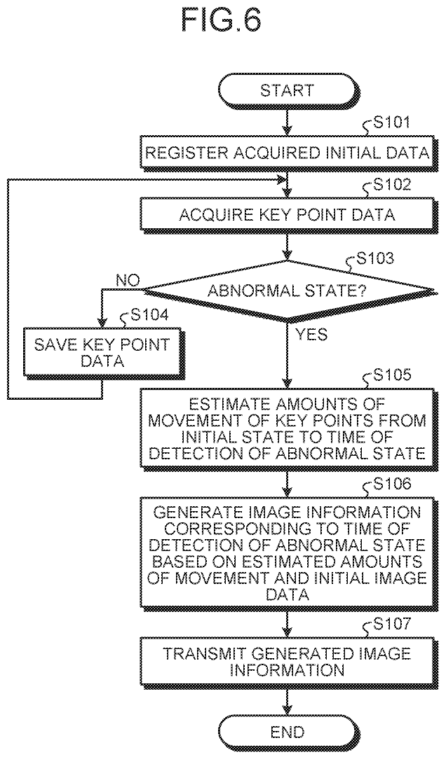

A processing procedure performed by the information processing device 20 according to the embodiment of the present disclosure will now be described using FIG. 6. FIG. 6 is a flowchart illustrating an example of a processing procedure of an information processing device according to the embodiment of the present disclosure. The processing procedure illustrated in FIG. 6 is executed by the control unit 230 included in the information processing device 20.

As illustrated in FIG. 6, upon acquiring initial data transmitted from the sensor device 10, the registration unit 231 registers the acquired initial data (step S101).

The acquisition unit 232 acquires, via the communication unit 210, key point data transmitted from the sensor device 10 (step S102).

The detection unit 233 executes processing of detecting an abnormal state of a monitoring target on the basis of the key point data acquired by the acquisition unit 232 (step S103).

In the case where an abnormal state of the monitoring target is not detected (step S103: No), the detection unit 233 saves the key point data acquired by the acquisition unit 232 (step S104), and the procedure returns to the processing procedure of step S102 described above.

On the other hand, in the case where an abnormal state of the monitoring target is detected by the detection unit 233 (step S103: Yes), the generation unit 234 estimates the amounts of movement of key points from the initial state to the time of detection of the abnormal state of the monitoring target (step S105).

Then, the generation unit 234 generates image information corresponding to the time of detection of the abnormal state on the basis of the estimated amounts of movement and initial image data initially registered for the monitoring target (step S106).

Further, the generation unit 234 transmits the generated image information to the administrator device 30 (step S107), and ends the processing procedure illustrated in FIG. 6.

### 2. SUPPLEMENTARY ITEMS

### 2-1. With Regard to Processing of Initial Data

In the embodiment described above, in order to protect privacy, the information processing device 20 can, when processing initial image data included in initial data, execute face detection processing or person area detection processing, and execute blurring processing or the like on the basis of the result of the above processing. Further, for example, in the case where the information processing device 20 monitors a care situation as a use scene, the information processing device 20 may not only execute blurring processing, but also when the caregiver is not wearing clothes, execute processing such as reproducing an image in a wearing state. Further, in the case where the information processing device 20 monitors a work situation of a robot as a use scene, the information processing device 20 may, when there is a portion falling under know-how or confidential information, perform blurring processing on the portion.

### 2-2. With Regard to Key Point Data

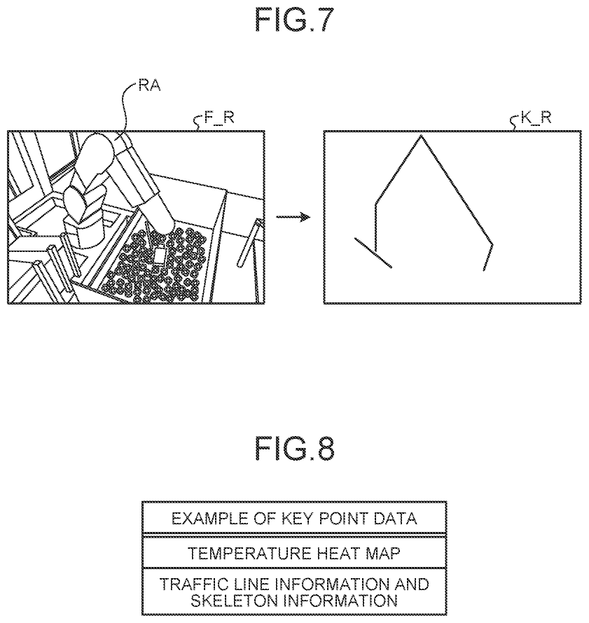

In the information processing system 1 according to the embodiment described above, an example is described in which skeleton information (coordinate information of joint points) of a person to be a monitoring target is used as key point data. Also in the case where, for example, a work situation of a robot arm is monitored, information processing according to the embodiment described above can be used by acquiring, as key point data, feature point information indicating feature points of the robot arm. FIG. 7 is a diagram illustrating an example of key point data of a robot arm. As illustrated in FIG. 7, in the case where a work situation of a robot arm RA is monitored as a use scene, the sensor device 10 can detect, as key point data, K_R of skeleton information of the robot arm from image data F_R of the robot arm RA, and use K_R.

The key point data used in the information processing system 1 according to the embodiment described above is not particularly limited to skeleton information of a monitoring target. FIG. 8 is a diagram illustrating variations of key point data. As illustrated in FIG. 8, in the information processing system 1, information of a temperature heat map acquired by a human sensor may be used as key points of a monitoring target. For example, the sensor device 10 uses a human sensor or the like to acquire information of a temperature heat map of a monitoring target. The sensor device 10 transmits the acquired information of a temperature heat map to the information processing device 20. The information processing device 20 estimates movement between potentially corresponding heat maps among temperature heat maps acquired from the sensor device 10, and uses the estimation for image generation. Specifically, for example, the information processing device 20 calculates to what place the portion of temperature potentially corresponding to the face in a temperature heat map is moved at the time of abnormality detection, and performs image generation by using the amount of movement.

Further, as illustrated in FIG. 8, in the information processing system 1, a combination of traffic line information and skeleton information of a monitoring target can be used as key point data. For example, the sensor device 10 may acquire not only initial data (initial image data and initial key point data) of a monitoring target, but also skeleton information of predetermined positions on a traffic line of the monitoring target obtained by performing key point detection at the positions. In the case where a plurality of persons is present in the same image, correspondence of skeleton information (key point data) may not be obtained between initial data and data at the time of occurrence of abnormality. In such a case, the movement of corresponding key points can be expressed by using traffic line information, and thus an effect of increasing the possibility that image information in which the state of the monitoring target is correctly restored can be generated can be expected in the information processing device 20.

### 2-3. With Regard to Conditions for Image Information Generation

Although in the embodiment described above an example is describe in which the information processing device 20 generates image information in the case where an abnormal state of a monitoring target is detected, the present disclosure is not limited thereto. For example, the information processing device 20 may, in response to a request from an administrator of the administrator device 30, generate image information corresponding to a date and time designated by the request.

### 3. OTHERS

Various programs for implementing an information processing method (see, for example, FIG. 6) to be executed by the information processing device 20 according to the embodiment of the present disclosure described above may be stored in a computer-readable recording medium or the like such as an optical disk, a semiconductor memory, a magnetic tape, or a flexible disk and distributed. At this time, the information processing device according to the embodiment of the present disclosure can implement the information processing method according to the embodiment of the present disclosure by installing and executing various programs in a computer.

Further, various programs for implementing an information processing method (see, for example, FIG. 6) to be executed by the information processing device 20 according to the embodiment of the present disclosure described above may be stored in a disk device included in a server on a network such as the Internet, and may be kept ready for downloading to a computer or the like. Further, functions provided by various programs for implementing an information processing method to be executed by the information processing device 20 according to the embodiment of the present disclosure may be obtained by cooperation of an OS and an application program. In this case, a portion other than the OS may be stored in a medium and distributed, or a portion other than the OS may be stored in an application server and kept ready for downloading to a computer or the like.

Among the pieces of processing described in the embodiment of the present disclosure described above, all or some of the pieces of processing described as ones performed automatically can be performed manually, or all or some of the pieces of processing described as ones performed manually can be performed automatically by a known method. In addition, the processing procedures, specific names, and information including various pieces of data and parameters described in the above document and the drawings can be arbitrarily changed unless otherwise specified. For example, the various pieces of information illustrated in the drawings are not limited to the information illustrated in the drawings.

Further, each component of the information processing device 20 according to the embodiment of the present disclosure described above is a functionally conceptual one, and the information processing device 20 is not necessarily required to be configured as illustrated in the drawings. For example, the generation unit 234 included in the information processing device 20 may be functionally divided into a function of generating image information and a function of transmitting the generated image information to the administrator device 30.

Further, the embodiments and the modification examples of the present disclosure can be combined as appropriate to the extent that the processing contents do not contradict. Further, the order of the steps illustrated in the flowchart according to the embodiment of the present disclosure can be changed as appropriate.

Hereinabove, embodiments and modification examples of the present disclosure are described; however, the technical scope of the present disclosure is not limited to the embodiments or the modification examples described above, and various changes can be made without departing from the gist of the present disclosure. Further, components of different embodiments and modification examples may be combined as appropriate.

### 4. HARDWARE CONFIGURATION EXAMPLE

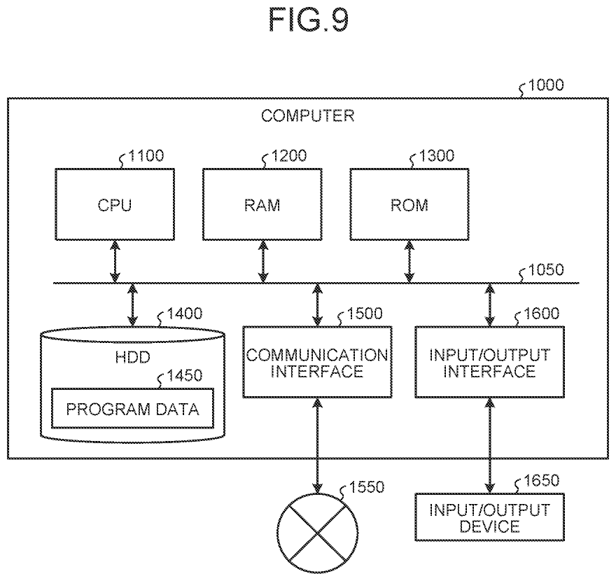

A hardware configuration example of a computer corresponding to the information processing device 20 according to the embodiment of the present disclosure described above will now be described using FIG. 9. FIG. 9 is a block diagram illustrating a hardware configuration example of a computer corresponding to an information processing device according to the embodiment of the present disclosure. FIG. 9 illustrates only an example of a hardware configuration of a computer corresponding to an information processing device according to the embodiment of the present disclosure, and the configuration does not need to be limited to the configuration illustrated in FIG. 9.

As illustrated in FIG. 9, a computer 1000 corresponding to the information processing device 20 according to the embodiment of the present disclosure includes a CPU (central processing unit) 1100, a RAM (random access memory) 1200, a ROM (read-only memory) 1300, an HDD (hard disk drive) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 expands, on the RAM 1200, programs stored in the ROM 1300 or the HDD 1400, and executes processing corresponding to various programs.

The ROM 1300 stores a boot program such as a BIOS (Basic Input/Output System) to be executed by the CPU 1100 when the computer 1000 is activated, a program depending on hardware of the computer 1000, etc.

The HDD 1400 is a computer-readable recording medium that non-temporarily records programs to be executed by the CPU 1100, data to be used by such programs, etc. Specifically, the HDD 1400 records program data 1450. The program data 1450 is an example of an information processing program for implementing an information processing method according to the embodiment and data to be used by such an information processing program.

The communication interface 1500 is an interface for the computer 1000 to connect to an external network 1550 (for example, the Internet). For example, via the communication interface 1500, the CPU 1100 receives data from another device, and transmits data generated by the CPU 1100 to another device.

The input/output interface 1600 is an interface for connecting an input/output device 1650 and the computer 1000. For example, the CPU 1100 receives data from an input device such as a keyboard or a mouse via the input/output interface 1600. Further, the CPU 1100 transmits data to an output device such as a display device, a speaker, or a printer via the input/output interface 1600. The input/output interface 1600 may function as a media interface that reads programs, etc. recorded on a predetermined recording medium (medium). The medium is, for example, an optical recording medium such as a DVD (digital versatile disc) or a PD (phase change rewritable disk), a magneto-optical recording medium such as an MO (magneto-optical disk), a tape medium, a magnetic recording medium, a semiconductor memory, or the like.

For example, in the case where the computer 1000 functions as an information processing device 100 according to the embodiment, the CPU 1100 of the computer 1000 executes an information processing program loaded on the RAM 1200, and thereby implements various processing functions to be executed by the units of the control unit 230 illustrated in FIG. 3.

That is, the CPU 1100, the RAM 1200, etc. implement information processing to be performed by the information processing device 20 according to the embodiment of the present disclosure by cooperation with software (the information processing program loaded on the RAM 1200).

### 5. CONCLUSIONS

An information processing device 20 according to an embodiment of the present disclosure includes a registration unit 231, an acquisition unit 232, and a generation unit 234. The registration unit 231 registers initial data indicating an initial state of a monitoring target. The acquisition unit 232 acquires feature point information indicating feature points of the monitoring target detected on a time series basis. On the basis of the initial data and the feature point information, the generation unit 234 generates image information of the monitoring target that is in agreement with a predetermined condition. Thereby, according to the embodiment of the present disclosure, a monitoring person can be provided with data that allows easy recognition of the situation of the monitoring target.

Further, in the embodiment of the present disclosure, the information processing device 20 further includes a detection unit 233 that detects an abnormal state of the monitoring target on the basis of feature point information. The generation unit 234 uses feature point information to estimate the amounts of movement of feature points from the initial state to the time of detection of an abnormal state of the monitoring target, and generates image information corresponding to the time of detection of the abnormal state on the basis of the estimated amounts of movement and a predetermined number of pieces of image data included in initial data initially registered for the monitoring target. Thereby, according to the embodiment of the present disclosure, data that allows easy recognition of the situation of the monitoring target at the time of occurrence of an abnormality can be provided while data transfer delay time is reduced and power consumption and communication cost are reduced. Further, according to the embodiment of the present disclosure, when providing data that allows easy recognition of the situation of the monitoring target at the time of occurrence of an abnormality, a reduction in data transfer delay time, consideration for privacy, and reductions in power consumption and communication cost can be achieved.

In the embodiment of the present disclosure, the feature point information includes skeleton information for specifying the attitude of the monitoring target. Thereby, according to the embodiment of the present disclosure, image information indicating a change in the attitude of the monitoring target can be provided.

Further, in the embodiment of the present disclosure, the feature point information includes position information for specifying the position of the monitoring target. Thereby, according to the embodiment of the present disclosure, for example, image information indicating a change in the attitude and position of the monitoring target can be provided.

Further, in the embodiment of the present disclosure, the feature point information includes traffic line information for specifying the traffic line of the monitoring target. Thereby, according to the embodiment of the present disclosure, for example, image information indicating a change in attitude along the trajectory of movement of the monitoring target can be provided.

In the embodiment of the present disclosure, the registration unit 231 executes processing for concealing at least part of initial data. Thereby, according to the embodiment of the present disclosure, for example, privacy of a person shown on an image can be protected in monitoring. Furthermore, according to the embodiment of the present disclosure, for example, leakage of confidential information shown on an image can be prevented.

The effects described in the present specification are merely explanatory or illustrative ones, and are not limitative. That is, the technology of the present disclosure can exhibit other effects that are clear to those skilled in the art from the description of the present specification, together with or instead of the above effects.

The technology of the present disclosure can also take the following configurations as ones belonging to the technical scope of the present disclosure.

(1)

An information processing device comprising:
a registration unit that registers initial data indicating an initial state of a monitoring target;
an acquisition unit that acquires feature point information indicating a feature point of the monitoring target detected on a time series basis; and
a generation unit that, on the basis of the initial data and the feature point information, generates image information of the monitoring target that is in agreement with a predetermined condition.
   (2)

The information processing device according to (1),
further comprising:
a detection unit that detects an abnormal state of the monitoring target on the basis of the feature point information, wherein
the generation unit uses the feature point information to estimate an amount of movement of the feature point from an initial state to a time of detection of an abnormal state of the monitoring target, and generates the image information corresponding to the time of detection of the abnormal state on the basis of the estimated amount of movement and a predetermined number of pieces of image data included in initial data initially registered for the monitoring target.
   (3)

The information processing device according to (1), wherein
the feature point information includes
skeleton information for specifying an attitude of the monitoring target.
   (4)

The information processing device according to (1), wherein
the feature point information includes
information based on a temperature heat map of the monitoring target.
   (5)

The information processing device according to (1), wherein
the feature point information includes
traffic line information for specifying a traffic line of the monitoring target.
   (6)

The information processing device according to (1), wherein
the registration unit
executes processing for concealing at least part of the initial data.
   (7)

An information processing method comprising:
a computer's:
registering initial data indicating an initial state of a monitoring target;
acquiring feature point information indicating a feature point of the monitoring target detected on a time series basis; and
on the basis of the initial data and the feature point information, generating image information of the monitoring target that is in agreement with a predetermined condition.
   (8)

An information processing program that causes a computer
to function as a control unit, the control unit being configured to:
register initial data indicating an initial state of a monitoring target;
acquire feature point information indicating a feature point of the monitoring target detected on a time series basis; and
on the basis of the initial data and the feature point information, generate image information of the monitoring target that is in agreement with a predetermined condition.

### REFERENCE SIGNS LIST

1 INFORMATION PROCESSING SYSTEM
10 SENSOR DEVICE
20 INFORMATION PROCESSING DEVICE
30 ADMINISTRATOR DEVICE
210 COMMUNICATION UNIT
220 STORAGE UNIT
221 MONITORING TARGET INFORMATION STORAGE UNIT
230 CONTROL UNIT
231 REGISTRATION UNIT
232 ACQUISITION UNIT
233 DETECTION UNIT
234 GENERATION UNIT

1. An information processing device comprising:
a registration unit that registers initial data indicating an initial state of a monitoring target;
an acquisition unit that acquires feature point information indicating a feature point of the monitoring target detected on a time series basis; and
a generation unit that, on the basis of the initial data and the feature point information, generates image information of the monitoring target that is in agreement with a predetermined condition.

2. The information processing device according to claim 1,
further comprising:
a detection unit that detects an abnormal state of the monitoring target on the basis of the feature point information, wherein
the generation unit uses the feature point information to estimate an amount of movement of the feature point from an initial state to a time of detection of an abnormal state of the monitoring target, and generates the image information corresponding to the time of detection of the abnormal state on the basis of the estimated amount of movement and a predetermined number of pieces of image data included in initial data initially registered for the monitoring target.

3. The information processing device according to claim 1, wherein
the feature point information includes
skeleton information for specifying an attitude of the monitoring target.

4. The information processing device according to claim 1, wherein
the feature point information includes
information based on a temperature heat map of the monitoring target.

5. The information processing device according to claim 1, wherein
the feature point information includes
traffic line information for specifying a traffic line of the monitoring target.

6. The information processing device according to claim 1, wherein
the registration unit
executes processing for concealing at least part of the initial data.

7. An information processing method comprising:
a computer's:
registering initial data indicating an initial state of a monitoring target;
acquiring feature point information indicating a feature point of the monitoring target detected on a time series basis; and
on the basis of the initial data and the feature point information, generating image information of the monitoring target that is in agreement with a predetermined condition.

8. An information processing program that causes a computer
to function as a control unit, the control unit being configured to:
register initial data indicating an initial state of a monitoring target;
acquire feature point information indicating a feature point of the monitoring target detected on a time series basis; and
on the basis of the initial data and the feature point information, generate image information of the monitoring target that is in agreement with a predetermined condition.
